(19) United States
(12) Patent Application Publication
(10) Pub. No.: US 2018/0003491 A1
(43) Pub. Date: Jan. 4, 2018

(54) THREE-DIMENSIONAL(3D) TEST STANDARD

(71) Applicant: 3M INNOVATIVE PROPERTIES COMPANY, St. Paul, MN (US)

(72) Inventors: Anthony J. Sabelli, Darien, CT (US); Glenn E. Casner, Woodbury, MN (US); Joseph C. Dingeldein, Blaine, MN (US); Shannon D. Scott, Hudson, WI (US)

(21) Appl. No.: 15/538,311

(22) PCT Filed: Dec. 18, 2015
(86) PCT No.: PCT/US2015/066599

§ 371 Date: Jun. 21, 2017

Related U.S. Application Data
(60) Provisional application No. 62/098,135, filed on Dec. 30, 2014.

(51) Int. Cl. G01B 21/04; G01B 21/20

(52) U.S. Cl. CPC G01B 21/042; G01B 21/20

(57) ABSTRACT

Three-dimensional test objects provide for assessment of a 3D scanner over a range of scales, frequencies, and/or depths. The test objects may include a substrate having a substantially planar top surface and a plurality of surface features. In some examples, the surface features include a plurality of wedges projecting above the plane of the top surface and extending radially outward from an origin to form a three dimensional star pattern. The shape of the surface features may be periodic or non-periodic. In other examples, the depth of the surface features is decoupled from their lateral frequency.

### TECHNICAL FIELD

The disclosure relates to calibration, qualification, and/or accuracy determination of 3D scanners.

### BACKGROUND

Three-dimensional (3D) scanners are devices that analyze shape, size, or position of an object of interest. A 3D scanner images an object from one or more views using one or more image capture devices and reconstructs a 3D representation. There are numerous 3D scanning contact and contactless technologies including: time-of-flight (TOF), multi-camera triangulation, structured light, shape from shading, modulated light, volumetric techniques (e.g., CT, MM, ultrasound, and PET), etc. Calibration and qualification of these 3D scanners helps to ensure that the 3D scan data accurately represents the object of interest. During the calibration and qualification process, the scanner determines its position, rotation, and behavior in relation to the scanned subject. The information gathered during the calibration and qualification process permits the system to identify the three-dimensional position of each acquired point and reconstruct an accurate digital three-dimensional model of the object.

### SUMMARY

In general, the disclosure is directed to test objects that provide for calibration, qualification and/or determination of 3D scanner accuracy over a range of scales, frequencies, and/or depths.

In one example, the disclosure is directed to a test object for assessment of a three-dimensional scanner comprising a substrate having a substantially planar top surface, the top surface having a substantially featureless core radius centered about an origin, and a plurality of surface features projecting above the planar top surface and extending radially outward from the featureless core radius toward a periphery of the substrate. Each of the plurality of surface features may include a proximal end at the featureless core radius and a distal end toward the periphery of the substrate, and may further have a height measured orthogonally to the substantially planar top surface that increases from the proximal end to the distal end. Each of the plurality of surface features may be further defined by a cross-section orthogonal to the planar top surface, and the cross-section may include one of a square, a rectangle, a triangle, a sinusoidal half-wave, and a two-dimensional dome. Each of the plurality of surface features may further include a textured surface. The test object may be comprised of one of a metal, a plastic, or a ceramic material.

The plurality of surface features projecting above the planar top surface of the substrate may define a first plurality of surface features, and the test object may further comprise a second plurality of surface features recessed below the planar top surface of the substrate, such that each of the second plurality of surface features define a recessed cavity extending radially outward from the featureless core radius toward the periphery of the substrate.

In another example, the disclosure is directed to a test object for assessment of a three-dimensional scanner, comprising a substrate having a substantially planar top surface; and a first plurality of three-dimensional surface features projecting above the planar top surface of the substrate, each of the plurality of surface features defined by a unique height measured orthogonally to the planar top surface, and a second plurality of three-dimensional surface features recessed below the planar top surface of the substrate, each of the plurality of surface features defining a recessed cavity having a unique depth measured orthogonally to the planar top surface of the substrate. At least one of the first plurality of three-dimensional surface features may comprise a rectangular prism or a hemisphere having an equator that is co-planar with the planar top surface of the substrate. At least one of the second plurality of three-dimensional surface features may comprise a recessed cavity defining a rectangular prism or a recessed cavity defining a hemisphere having an equator that is co-planar with the planar top surface of the substrate. Each of the first plurality of surface features and each of the second plurality of surface features may include a textured surface. The test object may be comprised of one of a metal, a plastic, or a ceramic material.

The details of one or more examples are set forth in the accompanying drawings and the description below. Other features and advantages of the invention will be apparent from the description and drawings, and from the claims.

### BRIEF DESCRIPTION OF DRAWINGS

FIG. 1 is a perspective view of an example 3D scanning test object.

FIG. 2A is a perspective view of another example 3D scanning test object.

FIG. 2B is a perspective view of another example 3D scanning test object.

FIG. 3 is a perspective view of another example 3D scanning test object.

FIG. 4 is a perspective view of another example 3D scanning test object.

FIG. 5 is a diagram illustrating an example 3D scanner environment with which the test object(s) of the present disclosure may be used.

FIG. 6 shows a portion of a rendered scan model of a test object such as the example test object shown in FIG. 1.

FIG. 7 shows example cross-sectional scan data from the rendered scan model of FIG. 5.

FIG. 8 shows example cross-sectional scan data such as may be obtained from a 3D scan of the test object shown in FIG. 2A.

FIG. 9 shows example cross-sectional scan data such as may be obtained from a 3D scan of the test object shown in FIG. 2B.

### DETAILED DESCRIPTION

The present disclosure describes three-dimensional (3D) test objects for use with 3D scanning technologies. Optical 3D scanning is a sensing technology used to capture the three-dimensional shape of a scanned object. Certain 3D scanning applications require acquisition of extremely precise measurements. Contactless 3D fingerprint scanning and 3D digital orthodontic scanning are examples of such applications. There are numerous 3D scanning contact and contactless technologies including: time-of-flight (TOF), multi-camera triangulation, structured light, shape from shading, modulated light, volumetric techniques (e.g., CT, MM, ultrasound, and PET), etc. The test objects described herein may be useful for calibration, qualification, and/or determination of resolution/accuracy of any type of 3D scanning system. It shall be understood, therefore, that the test object(s) of the present disclosure may be applicable to many different types of 3D scanning technologies, and the disclosure is not limited in this respect.

Calibration is defined as a measured comparison from one 3D scanner of interest to a suitable external “ground truth” object, i.e. a reference object with a known structure known to a tolerance known a priori to exceed that of the scanner of interest. The measured comparison may be scalar, for example, based on absolute or weighted magnitudes, or vectored to include orientation and direction. Qualification involves the process of determining whether a 3D scanner has met or exceeded performance or assurance specifications to be used for a specific application. For example, if a 3D scanner is used in a medical application such as digital orthodontics, then the scanner may be required to perform at a designated resolution within determined tolerance to consistently capture images of teeth. If a 3D scanner does not meet or exceed the desired resolution, then it would not receive qualification to be used in the identified application.

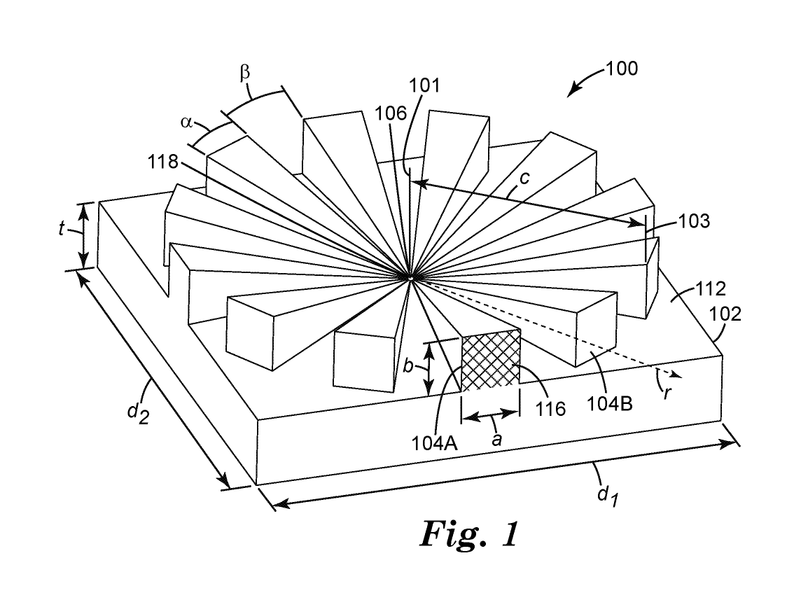

FIG. 1 is a perspective view of an example 3D scanning test object 100. Test object 100 includes a substrate 102 having a substantially planar top surface 112 and a plurality of surface features 104A-104N radially distributed on top surface 112 of substrate 102. In this example, substrate 102 is defined by a width, d₁, a length, d₂, and a thickness, t. Although substrate 102 is shown as being of a generally square shape, it shall be understood that the substrate may be rectangular, circular, or any other appropriate shape, and that the disclosure is not limited in this respect. Substrate 102 may be composed of any suitable metal, plastic, or ceramic material including, for example, but not limited to: aluminum, titanium, polyvinyl chloride (PVC), polyethylene, alumina, zirconia, and/or carbide.

Test object 100 is defined by an origin 106 and includes an unresolved (i.e., featureless) core radius 118 centered about origin 106. Each of the plurality of surface features 104A-104N is generally wedge-shaped, and extends radially outward from unresolved core radius 118 to form a three-dimensional star pattern. In the example of FIG. 1, surface features 104A-104N are of substantially equal size, shape, and cross-section; however, it shall be understood that the disclosure is not limited in this respect. Surface features 104A-104N may be composed of the same or different material as substrate 102.

Each surface feature 104A-104N is defined by a wedge angle, α. The spacing between surface features is defined by a spacing angle, β. The number of surface features, N, equals 12 in this example; however, it shall be understood that N may be any integer equal to or greater than 1, and that the disclosure is not limited in this respect.

The pattern formed by surface features 104A-104N of test object 100 may be symmetrical or unsymmetrical. For example, depending upon the number of surface features, N, the size and shape of each surface features, and/or whether the spacing angles between adjacent surface features is equivalent, the pattern formed by the surface features may be symmetrical or non-symmetrical. Thus, it shall be understood that the example test object 100 shown in FIG. 1 is but one example of a three-dimensional test object, and the disclosure is not limited in this respect.

Each surface feature 104A-104N is further defined by a length, c. The length, c, is measured from a proximal end 101 at the unresolved core radius 118 to a distal end 103 of the surface feature. In this example, the plurality of surface features 104A-104N are of substantially equivalent length. Each surface feature 104A-10N further has a substantially square-shaped cross-section along the entire length, c. The cross-section is defined as being orthogonal to the plane of top surface 112 and orthogonal to a radius, r, lying in the plane defined by top surface 112 and extending radially outward from an origin 106. For example, the distal end 103 of surface feature 104A has a substantially square-shaped cross section (indicated by shaded area 116) having a width, a, and a height, b. The width, a, is measured in the plane formed by top surface 112 and perpendicular to radius, r. The height, b, of each surface feature 104A-104N is measured orthogonally to the plane of top surface 112. Both the width, a, and the height, b, of each surface feature increases from the proximal end 101 to the distal end 103. In this example, the width, a, and the height, b, are equivalent along the entire length of each surface feature, resulting in a substantially square shaped cross-section at any given radius, r along the length of each surface feature.

In this example, the length and width of each surface feature 104A-104N tapers down along the length c such that a substantially square cross-section is maintained along the entire length of the surface feature. Thus, a cross-section taken at any other point along the length of surface feature 104A in FIG. 1 would also be substantially square-shaped and have a height equal to the width at that point. It shall be understood, however, that the shape of the cross-section need not be maintained along the entire length of each surface feature, and that the disclosure is not limited in this respect.

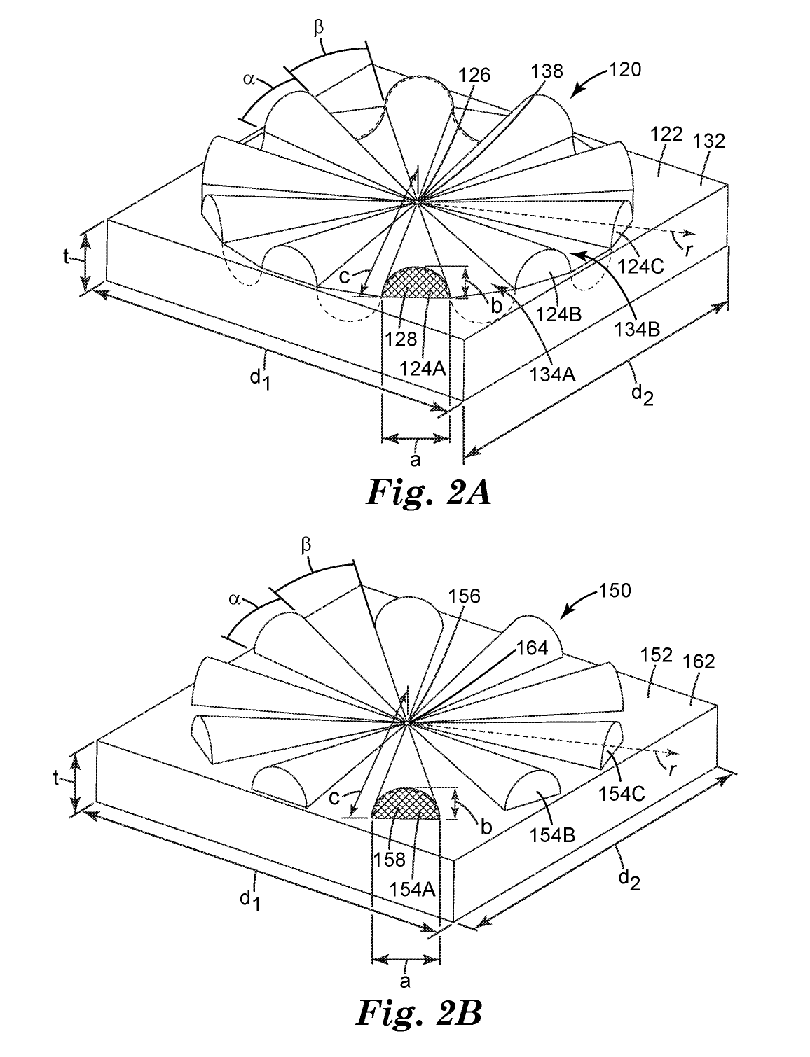

FIG. 2A is a perspective view of another example 3D scanning test object 120. Test object 120 includes a substrate 132 having a substantially planar top surface 122 and a plurality of three-dimensional surface features 124A-124N and 134A-134N. Surface features 124A-124N project above the planar top surface 122 of the substrate 132, and have a height (which may also referred to as an amplitude) measured orthogonally to the planar top surface 122 of the substrate 132. The height of each surface feature 124A-124N increases from the proximal end to the distal end. Surface features 134A-134N are recessed below the planar top surface 122 of the substrate 132, such that each of the plurality of surface features 134A-134N define a recessed cavity having a depth measured orthogonally to planar top surface 122 of substrate 132. The depth of each surface feature 134A-134N increases from the proximal end to the distal end.

In this example, substrate 132 is defined by a width, d₁, a length, d₂, and a thickness, t. Although substrate 132 is shown as being of a generally square shape, it shall be understood that the substrate may be rectangular, circular, or any other appropriate shape, and that the disclosure is not limited in this respect. Substrate 132 may be composed of any suitable metal, plastic, or ceramic material including, for example, but not limited to: aluminum, titanium, polyvinyl chloride (PVC), polyethylene, alumina, zirconia, and/or carbide.

Test object 120 is defined by an origin 126 and includes an unresolved (i.e., featureless) core radius 138 centered about origin 126. The plurality of surface features 124A-124N and 134A-134N of test object 120 extend radially outward from unresolved core radius 138 to form a three-dimensional star pattern. In the example of FIG. 2A, surface features 124A-124N and 134A-134N are of substantially equal size, shape, and cross-section. It shall be understood that the disclosure is not limited in this respect.

Each surface feature 124A-124N is defined by a wedge angle, a. The spacing between surface features is defined by a spacing angle, β (not shown in FIGS. 2A and 2B). The number of surface features, N, equals 10 in this example; however, it shall be understood that N may be any integer equal to or greater than 1, and that the disclosure is not limited in this respect.

The pattern formed by surface features 124A-124N and 134A-134N of test object 120 may be symmetrical or unsymmetrical. For example, depending upon the number of surface features, N, the size and shape of each surface features, and/or whether the spacing angles between adjacent surface features is equivalent, the pattern formed by the surface features may be symmetrical or non-symmetrical. Thus, it shall be understood that the example test object 120 shown in FIG. 2A is but one example of a three-dimensional test object, and the disclosure is not limited in this respect.

Each surface feature 124A-124N and 134A-134N is further defined by a length, c. The length, c, is measured from a proximal end at the unresolved core radius 138 to a distal end of the surface feature toward the periphery of substrate 132. In this example, each surface feature 124A-124N has a dome-shaped cross-section along the entire length, c. The cross-section is defined as being orthogonal to the plane of top surface 122 and orthogonal to a radius, r, lying in the plane defined by top surface 122 and extending radially outward from origin 126 of the test object 120. Thus, in this example, surface features 124A-124N and 134A-134N form a periodic sinusoidal waveform when viewed in cross section at any radius, r, of the test object 120. For example, the distal end of surface feature 124A has a dome-shaped cross section (indicated by shaded area 124B. Specifically, in this example, the cross-section (indicated by shaded area 128) of each surface feature 124A-124N (and similarly for surface features 134A-134N) is defined by a sinusoidal half-wave having a height or amplitude, b. The periodic sinusoidal waveform formed by surface features 124A-124N and 134A-134N at a given radius, r, has an amplitude, b, and a period, T, given by twice the dimension of the half-wave (T=2a). However, it shall be understood that other periodic waveforms, such as square waveforms (see, e.g., FIG. 1), triangle waveforms, or other periodic waveforms may also be used, and that the disclosure is not limited in this respect. In addition, as described above, sinusoidal or other periodic waveform shapes having different frequencies may be used to construct each of surface features 124A-124N. Moreover, the cross-section may be a two-dimensional curve having any curved shape, and need not be a sinusoidal or any other periodic curved shape. Thus, the descriptions of the shape of the curve forming the cross-section of surface features 124A-124N are for example purposes only, and the disclosure is not limited in this respect.

In this example, the sizes of each surface feature 124A-124N and 134A-134N are substantially equivalent; however, it shall be understood that the surface features 124A-124N and 134A-134N may vary in size, and that the disclosure is not limited in this respect.

As is also shown in this example, the height or amplitude of each surface feature 124A-124N (and likewise 134A-134N) tapers down along the length c such that the ratio of the amplitude and the frequency (and thus the cross-sectional shape of the surface feature) is maintained along the entire length c of the surface feature. It shall be understood, however, that the shape of the cross-section need not be maintained along the entire length of each surface feature, and that the disclosure is not limited in this respect.

FIG. 2B is a perspective view of another example 3D scanning test object 150. Test object 150 includes a substrate 162 having a substantially planar top surface 152 and a plurality of three-dimensional surface features 154A-154N. Surface features 154A-154N project above the planar top surface 152 of the substrate 162. The height or amplitude of each surface feature 154A-154N increases from the proximal end at the featureless core radius 164 to the distal end.

In this example, substrate 162 is defined by a width, d₁, a length, d₂, and a thickness, t. Although substrate 162 is shown as being of a generally square shape, it shall be understood that the substrate may be rectangular, circular or any other appropriate shape, and that the disclosure is not limited in this respect. Substrate 162 may be composed of any suitable metal, plastic, or ceramic material including, for example, but not limited to: aluminum, titanium, polyvinyl chloride (PVC), polyethylene, alumina, zirconia, and/or carbide.

Test object 150 is defined by an origin 156 and includes an unresolved (i.e., featureless) core radius 164 centered about origin 156. The plurality of surface features 154A-154N of test object 150 extend radially outward from unresolved core radius 138 to form a three-dimensional star pattern. In the example of FIG. 2B, surface features 154A-154N are of substantially equal size, shape, and cross-section. It shall be understood, however, that the disclosure is not limited in this respect.

Each surface feature 154A-154N is defined by a wedge angle, a. The spacing between surface features is defined by a spacing angle, β (not shown in FIGS. 2A and 2B). The number of surface features, N, equals 10 in this example; however, it shall be understood that N may be any integer equal to or greater than 1, and that the disclosure is not limited in this respect.

The pattern formed by surface features 154A-15N of test object 150 may be symmetrical or unsymmetrical. For example, depending upon the number of surface features, N, the size and shape of each surface features, and/or whether the spacing angles between adjacent surface features is equivalent, the pattern formed by the surface features may be symmetrical or non-symmetrical. Thus, it shall be understood that the example test object 150 shown in FIG. 2B is but one example of a three-dimensional test object, and the disclosure is not limited in this respect.

Each surface feature 154A-154N is further defined by a length, c. The length, c, is measured from a proximal end at the unresolved core radius 164 to a distal end of the surface feature relatively nearer the periphery of substrate 162. In this example, each surface feature 154A-154N has a dome-shaped cross-section along the entire length, c. The cross-section is defined as being orthogonal to the plane of top surface 152 and orthogonal to a radius, r, lying in the plane defined by top surface 152 and extending radially outward from origin 156 of the test object 150. Thus, in this example, surface features 154A-154N form a periodic half-wave rectified sinusoidal waveform when viewed in cross section at any radius, r, of the test object 150 (see, e.g., FIG. 9). For example, the distal end of surface feature 154A has a dome-shaped cross section (indicated by shaded area 154B. Specifically, in this example, the cross-section 158 of each surface feature 124A-124N is defined by a sinusoidal half-wave having an amplitude, b. The half-wave rectified sinusoidal waveform formed by surface features 154A-154N has an amplitude, b, and a period, T, given by twice the dimension of the half-wave (T=2a). However, it shall be understood that other periodic waveforms, such as square waveforms (see, e.g., FIG. 1), sinusoids (see, e.g., FIG. 2), triangle waveforms, or other periodic waveforms may also be used, and that the disclosure is not limited in this respect. In addition, as described above, sinusoidal or other periodic waveform shapes having different frequencies may be used to construct each of surface features 154A-154N. Moreover, the cross-section may be a two-dimensional curve having any curved shape, and need not be a sinusoidal or any other periodic curved shape. Thus, the descriptions of the shape of the curve forming the cross-section of surface features 154A-154N are for example purposes only, and the disclosure is not limited in this respect.

In this example, the sizes of each surface feature 154A-154N are substantially equivalent; however, it shall be understood that the surface features 154A-154N may vary in size, and that the disclosure is not limited in this respect.

As is also shown in this example, the height or amplitude of each surface feature 154A-154N tapers down along the length c such that the ratio of the amplitude and the frequency (and thus the cross-sectional shape of the surface feature) is maintained along the entire length c of the surface feature. It shall be understood, however, that the shape of the cross-section need not be maintained along the entire length of each surface feature, and that the disclosure is not limited in this respect.

Example test objects 100, 120, and 150 and other test objects according to the present disclosure, permit calibration and/or assessment of 3D scanner accuracy over a range of scales, frequencies, or depths. Test objects according to the present disclosure may be manufactured in various sizes depending upon the scale or spatial-frequencies of the object to be measured. For example, for very high-resolution (fine grain) measurements, such as those required for contactless 3D fingerprint scanning or 3D orthodontic scanning, the diameter of the unresolved core 118 may be on the order of 1-10 microns, the surface feature angle, α, may range from 0 degrees to 90 degrees, and spacing angle, β, may vary from 0 degrees to 90 degrees, and the number of surface features may include at least 1 surface feature, and in some examples may include at least 4 surface features, and up to any suitable number of surface features. The length, c, of the surface features may range from 10 to 100 microns up to 10 centimeter or more. The radius, r, as measured from the center of the core radius may range from 10 to 100 microns up to 10 centimeters or more. The number of cycles per revolution (a complete 360 scan) at each radius will depend upon the number of surface features, and may therefore include at least 1 cycle per revolution (2π), and in some examples may include at least 4 cycles per revolution, and up to any suitable number of cycles per revolution.

For mid- to low-resolution measurements, the diameter of the unresolved core 118, 126, 156 may be on the order of 1 centimeter, the surface feature angle, α, may range from 0 degrees to 90 degrees, and spacing angle, β, may vary from 0 degrees to 90 degrees, and the number of surface features may include at least 1 surface feature, and in some examples may include at least 4 surface features, and up to any suitable number of surface features. The length, c, of the surface features may range from 10 centimeters to 1 meter. The radius, r, as measured from the center of the core radius may range from 10 centimeters to 1 meter or more, and will depend at least in part on the size of the featureless core radius and the length, c, of the surface features. The number of cycles per revolution (a complete 360 scan) at each radius will depend upon the number of surface features, and may therefore include at least 1 cycle per revolution, and in some examples may include at least 4 cycles per revolution, and up to any suitable number of cycles per revolution.

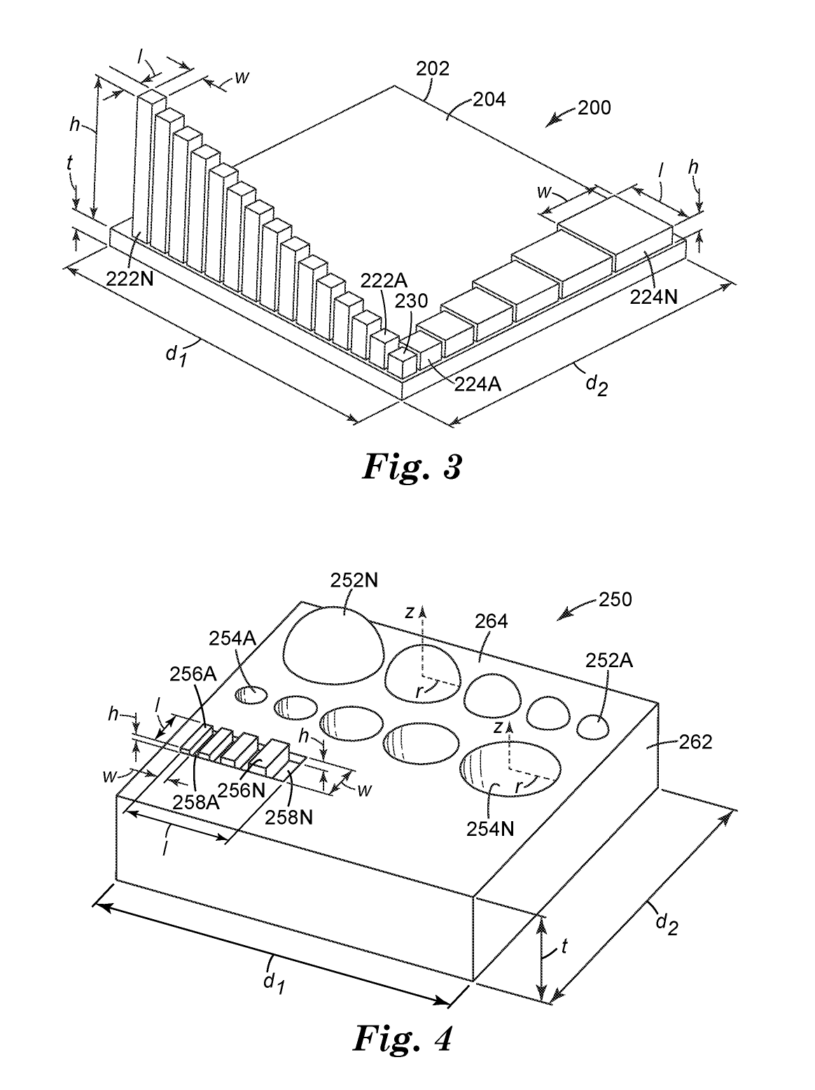

In the examples of FIGS. 1 and 2, the height (or depth) of the feature is tied to the lateral frequency. Lateral frequency in this context refers to the rate (along a circular cross-sectional path) at which the surface features oscillate or repeat. This concept is described in further detail below with respect to FIGS. 7-9. The depth resolution of some 3D scanners is coarser than the lateral resolution. For this reason, in certain examples, it may be advantageous to decouple the depth of the test object from lateral frequency so as to probe each independently. Examples of test objects in which the depth of the feature is decoupled from the lateral frequency are shown in FIGS. 3 and 4.

FIG. 3 is a perspective view of another example 3D scanning test object 200. Test object 200 includes a substrate 202 having a substantially planar top surface 204 and a plurality of surface features indicated by reference numerals 222A-222N, 224A-224N, and 230. Substrate 202 is defined by a width, d₁, a length, d₂, and a thickness, t. Although the substrate 202 is shown as being of a generally square shape, it shall be understood that substrate 202 may be rectangular, circular or any other appropriate shape, and that the disclosure is not limited in this respect. Substrate 202 may be composed of any suitable metal, plastic, or ceramic material including, for example, but not limited to: aluminum, titanium, polyvinyl chloride (PVC), polyethylene, alumina, zirconia, and/or carbide.

Surface features 222A-222N, 224A-224N, and 230 are shaped generally as rectangular prisms having a width, w, a length, l, and a height, h, measured in a z-direction orthogonal to the plane of the top surface 204. Surface features 222A-222N and 230 have equal lengths and widths, but different heights. Surface features 224A-224N and 230 have different lengths, widths, and heights. The number of surface features 222A-22N is defined by a first integer, N₁, while the number of surface features 224A-224N is defined by a second integer, N₂. In this example, N₁ equals 14 and N₂ equals 6 (not including surface feature 230); however, it shall be understood that N₁ and N₂ may be any integer equal to or greater than 1, and that the disclosure is not limited in this respect. Surface features 222A-222N, 224A-224N, and 230 may be composed of the same or different material as substrate 202. In this arrangement, the depth of the features is decoupled from their lateral dimensions. This allows the resolution of a scanner to be independently evaluated along different coordinate axes.

FIG. 4 is a perspective view of another example 3D scanning test object 250. Test object 250 includes a substrate 262 having a substantially planar top surface 264 and a plurality of surface features indicated by reference numerals 252A-252N, 254A-254N, and 256A-256N. Substrate 262 is defined by a width, d₁, a length, d₂, and a thickness, t. Although substrate 262 is shown as being of a generally square shape, it shall be understood that substrate 262 may be rectangular, circular or any other appropriate shape, and that the disclosure is not limited in this respect. Substrate 262 may be composed of any suitable metal, plastic, or ceramic material including, for example, but not limited to: aluminum, titanium, polyvinyl chloride (PVC), polyethylene, alumina, zirconia, and/or carbide.

Example surface features 252A-252N are hemisphere-shaped features projecting above the plane of top surface 264, and having an equator in the plane of top surface 264. The size of each surface feature 252A-252N is defined by a radius, r. Each surface feature 252A-252N has a different radius. The number of surface features 252A-252N is defined by a first integer, which may be any integer greater than or equal to one.

Example surface features 254A-254N are hemisphere-shaped features projecting below the plane of top surface 264, and having an equator in the plane of top surface 264. The size of each surface feature 254A-254N is defined by a radius, r. Each surface feature 254A-254N has a different radius. The number of surface features 254A-254N is defined by a second integer, N₂, which may be any integer greater than or equal to one.

In this example, N₁ equals 5 and N₂ equals 5; however, it shall be understood that N₁ and N₂ may be any integer equal to or greater than 1, that N₁ and N₂ may or may not be equal to each other, and that the disclosure is not limited in this respect.

Example surface features 256A-256N are rectangular-prism shaped features projecting above the plane of top surface 264. In this example, these surface features 256A-256N alternate with rectangular-prism shaped features 258A-258N projecting below the plane of top surface 264. The size of each surface feature 256A-256N and 258A-258N are defined by a width, w, measured in an x-direction lying in the plane of the top surface; a length, l, measured in a y-direction lying the plane of the top surface and orthogonal to the x-direction; and a height, h, measured in a z-direction orthogonal to the plane of the top surface 204. The length, width, and height of each surface feature may vary. The number of surface features 256A-256N is defined by a third integer, N₃, which may be any integer greater than or equal to one. The number of surface features 258A-258N is defined by a fourth integer, N₄, which may be any integer greater than or equal to one. Surface features 252A-252N, 254A-254N, 256A-256N, and 258A-258N may be composed of the same material as substrate 202.

Example test objects 200 and 250, and other test objects according to the present disclosure, permit calibration and/or assessment of 3D scanner accuracy over a range of scales, frequencies, or depths. Test objects according to the present disclosure may be manufactured in various sizes depending upon the scale or spatial-frequencies of the object to be measured. For example, the length, width, and height (or depth) of the surface features may range from 1 to 1000±1-10 microns, and the number of surface features may include at least 2 surface features and up to any suitable number of surface features.

In some applications, there may be advantages to decoupling the lateral feature size from the depth feature size that would be achieved using the test objects of FIGS. 3 and 4. This may allow the scanner to be independently evaluated along different coordinate axes. For example, in a stereo vision based camera, the error may be of the form:

$$dZ = \frac{{Z}^{2}}{( b \times f \times d L )}$$

where Z is the coordinate axis corresponding to distance from the scanner, b is the “baseline” between the stereo views, f is the focal length of each view, and dL is the resolution along the coordinate axes orthogonal to Z. In order to understand the error dZ and dL independently, it is advantageous to decouple the depth and lateral feature size in the calibration standard.

The test objects described herein may be fabricated from any suitable material capable of achieving and maintaining the desired dimensional precision and stability. For example, the test objects of the present disclosure may be any suitable metal, plastic, or ceramic material including, for example, but not limited to: aluminum, titanium, polyvinyl chloride (PVC), polyethylene, alumina, zirconia, and/or carbide. It shall therefore be understood that the example materials described herein are for example purposes only, and that the disclosure is not limited in this respect.

In some examples, the surface of the test object may be “smooth” relative to the dimensional tolerances of the test object. In other examples, the surface of the test object may include some amount of surface texture. Depending on the specific scanning technique, it may be advantageous for the test object to include some amount of surface contrast and/or surface texture. For example in stereo reconstruction of a “smooth” surface, it may be difficult to ascertain which parts of one image correspond to which parts of another image. This is known as the “stereo correspondence” problem. This problem may be aided by a target with clear and distinct optical surface features, which may help the scanner more accurately reconstruct the 3D image. The surface features may include contrast in the coloration of the surface, and/or may include texture provided on the surface of the test object. Examples may include, but are not limited to: vertical, horizontal, radial, cross-hatched, isotropic, and/or circular texture patterns.

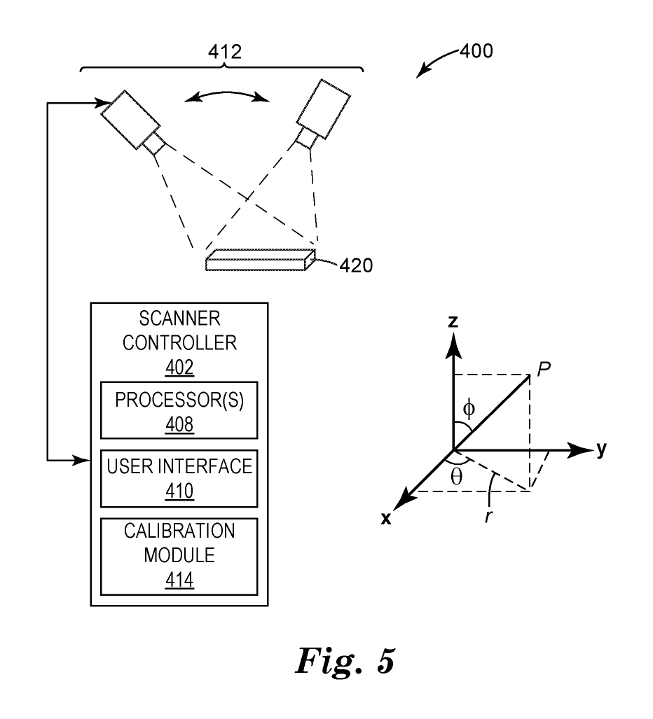

In use, any of the test object(s) of FIGS. 1-4, or other test objects described herein, may be used for calibration, qualification, or determination of accuracy of a 3D scanner. FIG. 5 is a diagram illustrating an example 3D scanner environment with which the test object(s) of the present disclosure may be used. A 3D scanning system 400 includes one or more light sources/cameras 412 and a scanner controller 402. Scanner controller 402 includes one or more processors 408, a user interface 410 (which may include a display, keyboard or key pad, touchscreen, microphone, speakers, mouse, and/or other user interface elements), and a calibration module 414. A 3D scanning test object 420, such as any of test objects of FIGS. 1-4, or any other 3D scanning test object described herein, is placed in an appropriate position to be scanned. The position may depend upon the type of 3D scanner and/or the intended application of the 3D scanner (e.g., contactless 3D fingerprint scanning, 3D orthodontic scanning, or other application). 3D light source/cameras 412 project energy (e.g., laser light, UV light, ultrasound, etc.) upon the surface of test object 420 from multiple points of view. In some examples, the light source/cameras 412 may be rotated or translated with respect to the test object to acquire 3D scan data from multiple views. Alternatively, the test object may be moved with respect to the light source/cameras 412. Each point of the surface of test object 420 is captured by one or more of light source/cameras 412, and the x, y, and z coordinates of each acquired point are recorded by scanner controller 402. The resulting “point cloud” is a file containing a large amount of 3D scan data for each point of the scanned surface. The 3D scan data showing the 3D shape of the scanned surface of test object 420 may be displayed on a computer screen or other user interface 410.

The processor 408 may include, for example, one or more general-purpose microprocessors, specially designed processors, application specific integrated circuits (ASIC), field programmable gate arrays (FPGA), a collection of discrete logic, and/or any type of processing device capable of executing the techniques described herein. In some embodiments, the processor 408 (or any other processors described herein) may be described as a computing device. In some embodiments, a memory, not shown, may be configured to store program instructions (e.g., software instructions) that are executed by the processor 108 to carry out the processes or methods of calibrating, qualifying, and/or determining 3D scanner accuracy or resolution as described herein. In other embodiments, the processes or methods described herein may be executed by specifically programmed circuitry of the processor 108. In some embodiments, the processor 408 may thus be configured to execute the techniques for calibrating and qualifying a 3D scanner described herein. The processor 408 (or any other processors described herein) may include one or more processors.

Scanner controller 402 may include a calibration module 414 which stores the acquired 3D scan data obtained during the scan of the test object 420. Calibration module 414 may also store the known dimensions of 3D test object 420. Calibration module 414 may further store one or more software modules that, when executed by processor(s) 408, perform calibration or qualification procedures for the 3D scanner, or perform accuracy determination procedures for the 3D scanner (e.g., determine the minimum resolvable feature size).

During calibration, the acquired scan data obtained during the scan of test object 420 may be compared to the known dimensions of the test object 420 stored in the memory of scanner controller 402. The feature sizes may then be determined and calibrated and stored by scanner controller 420.

The 3D test objects may also be used for qualification of 3D scanning system 400. The acquired 3D scan data of test object 420 may be compared to the known dimensions of test object 420 stored in the calibration module 414 of scanner controller 402. If the series of measurements in the 3D scan data of the 3D test object agree (within certain tolerances) with the known dimensions of the test object, 3D scanning system 400 may be said to be “qualified” by the test object 420.

The 3D test objects of the present disclosure may also be used to determine the accuracy of the 3D scanning system. For example, the 3D test objects may be used to determine the minimum feature size resolvable by the 3D scanning system.

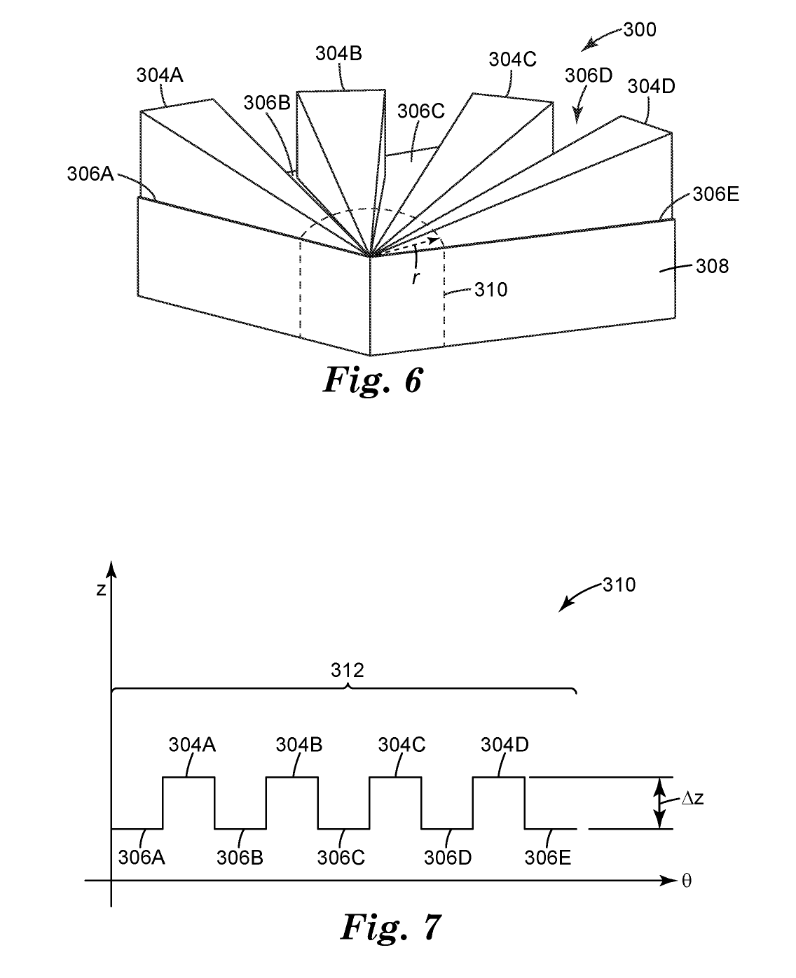

Assume, for example, that test object 420 is co-planar with the coordinate system shown in FIG. 5. FIG. 6 shows a portion of a rendered scan model 300 of a test object such as the example test object shown in FIG. 1. The rendered scan 300 includes surface features 304A-304D, spaces 306A-306E between the surface features, and substrate 308. Dashed line 310 indicates a cross-section of the rendered scan data taken at radius r, from the center point 320 of test object 300.

FIG. 7 is a graph showing the height (z) versus angle (0) of the example cross-section 310 of FIG. 6. To determine the smallest feature size resolvable by a given 3D scanner, the cross-sectional data from the scan may be analyzed. In the example of FIG. 7, surface features 304A-304D form a periodic square waveform 312 when viewed in cross-section at any given radius. The difference between the maximum and the minimum of the square wave (Δz) may be determined for each cross-sectional radius. At some point, the scanned data will look more like an “average” surface rather than showing distinct surface features. When the difference satisfies a threshold, the amplitude (height) of the square waveform may be used as the minimum feature size resolvable by the 3D scanner.

In other examples, analysis similar to those used with 2D images may be applied to analysis of the 3D images. For example, the cross sectional contour of a 3D test object may be seen as a proxy for image intensity of a 2D image when imaging a 3D target. Thus, any measurements used for analysis images of 2D targets, such as the Contrast Transfer Function (CTF), Modulation Transfer Function (MTF), etc., may also be used on the plot of the cross sectional height for analysis of 3D images.

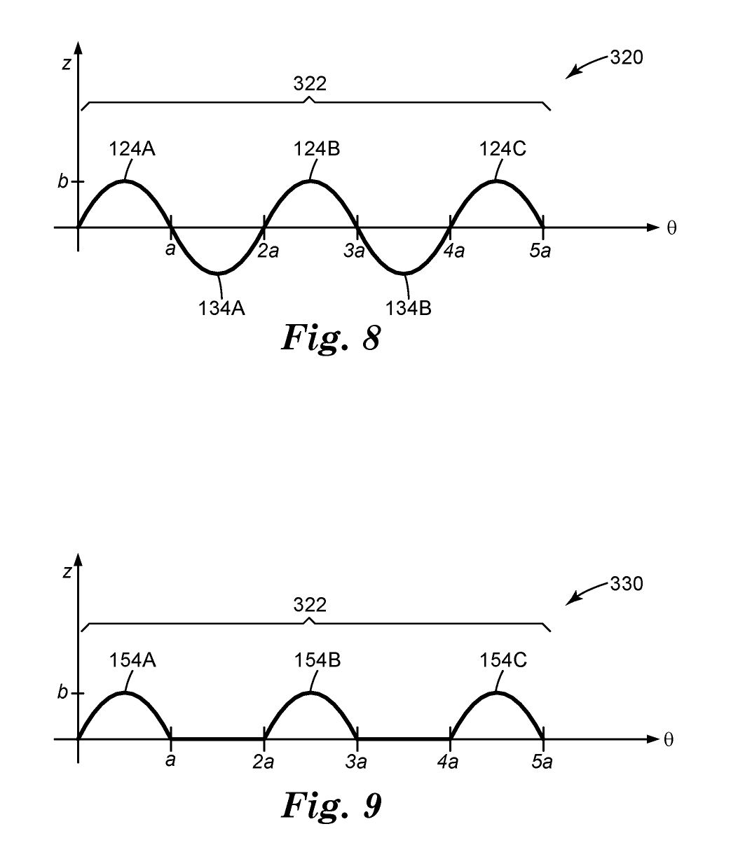

FIG. 8 shows a graph 320 of example cross-sectional scan data such as may be obtained from a 3D scan of the test object 120 shown in FIG. 2A. Graph 320 shows the height or amplitude (z) versus angle (θ) at a given radius of example 3D test object 120. Surface features 124A-124C and 128A-128C form a sinusoidal waveform 322 when viewed in cross-section at any given radius.

FIG. 9 shows a graph 330 of example cross-sectional scan data such as may be obtained from a 3D scan of the test object 150 shown in FIG. 2B. Graph 330 shows the height or amplitude (z) versus angle (0) at a given radius of example 3D test object 150. Surface features 154A-154C form a half-wave rectified sinusoidal waveform 332 when viewed in cross-section at any given radius.

### Exemplary Embodiments

Item 1. A test object for assessment of a three-dimensional scanner comprising: a substrate having a substantially planar top surface, the top surface having a substantially featureless core radius centered about an origin; and a plurality of surface features projecting above the planar top surface and extending radially outward from the featureless core radius toward a periphery of the substrate.

Item 2. The test object of Item 1, wherein each of the plurality of surface features includes a proximal end at the featureless core radius and a distal end toward the periphery of the substrate, and further having a height measured orthogonally to the substantially planar top surface that increases from the proximal end to the distal end.

Item 3. The test object of Item 2, wherein each of the plurality of surface features is further defined by a cross-section orthogonal to the planar top surface.

Item 4. The test object of Item 3, wherein the cross-section is one of a square, a rectangle, a triangle, a sinusoidal half-wave, and a two-dimensional dome.

Item 5. The test object of Item 3, wherein the cross-section is defined by a width lying in the plane of the planar top surface and a height orthogonal to the plane of the planar top surface, and wherein the width and the height are equivalent.

Item 6. The text object of any one of Item 1-5, wherein the plurality of surface features are of substantially equal length and cross-sectional shape.

Item 7. The test object of any one of Item 1-6, wherein each of the plurality of surface features includes a textured surface.

Item 8. The test object of any one of Item 1-7 comprised of one of a metal, a plastic, or a ceramic material.

Item 9. The test object of any one of Item 1-8, wherein the plurality of surface features projecting above the planar top surface of the substrate define a first plurality of surface features, the test object further comprising a second plurality of surface features recessed below the planar top surface of the substrate, such that each of the second plurality of surface features define a recessed cavity extending radially outward from the featureless core radius toward the periphery of the substrate.

Item 10. The test object of Item 9 wherein each of the second plurality of surface features recessed include a depth measured orthogonally to planar top surface of substrate that increases from the proximal end to the distal end.

Item 11. The test object of Item 9 wherein the first plurality of surface features and the second plurality of surface features form an alternating three-dimensional pattern projecting above and recessed below the planar surface of the substrate.

Item 12. The test object of Item 11 wherein a cross-section of the alternating three-dimensional pattern at any radius measured from the origin is a periodic waveform.

Item 13. The test object of Item 12 wherein the periodic waveform is one of a square waveform or a sinusoidal waveform.

Item 14. A test object for assessment of a three-dimensional scanner, comprising: a substrate having a substantially planar top surface; and a first plurality of three-dimensional surface features projecting above the planar top surface of the substrate, each of the plurality of surface features defined by a unique height measured orthogonally to the planar top surface; and a second plurality of three-dimensional surface features recessed below the planar top surface of the substrate, each of the plurality of surface features defining a recessed cavity having a unique depth measured orthogonally to the planar top surface of the substrate.

Item 15. The test object of Item 14 wherein at least one of the first plurality of three-dimensional surface features comprises a rectangular prism.

Item 16. The test object of Item 15 wherein at least one of the second plurality of three-dimensional surface features comprises a recessed cavity defining a rectangular prism.

Item 17. The test object of any one of Item 14-16, wherein at least one of the first plurality of three-dimensional surface features comprises a hemisphere having an equator that is co-planar with the planar top surface of the substrate.

Item 18. The test object of Item 17 wherein at least one of the second plurality of three-dimensional surface features comprises a recessed cavity defining a hemisphere having an equator that is co-planar with the planar top surface of the substrate.

Item 19. The test object of any one of Item 14-18, wherein each of the first plurality of surface features and each of the second plurality of surface features include a textured surface.

Item 20. The test object of any one of Item 14-19 comprised of one of a metal, a plastic, or a ceramic material.

Various examples have been described. These and other examples are within the scope of the following claims.

1. A test object for assessment of a three-dimensional scanner comprising:
a substrate having a substantially planar top surface, the top surface having a substantially featureless core radius centered about an origin; and
a plurality of surface features projecting above the planar top surface and extending radially outward from the featureless core radius toward a periphery of the substrate.

2. The test object of claim 1, wherein each of the plurality of surface features includes a proximal end at the featureless core radius and a distal end toward the periphery of the substrate, and further having a height measured orthogonally to the substantially planar top surface that increases from the proximal end to the distal end.

3. The test object of claim 2, wherein each of the plurality of surface features is further defined by a cross-section orthogonal to the planar top surface.

4. The test object of claim 3, wherein the cross-section is one of a square, a rectangle, a triangle, a sinusoidal half-wave, and a two-dimensional dome.

5. The test object of claim 3, wherein the cross-section is defined by a width lying in the plane of the planar top surface and a height orthogonal to the plane of the planar top surface, and wherein the width and the height are equivalent.

6. The text object of claim 1 wherein the plurality of surface features are of substantially equal length and cross-sectional shape.

7. The test object of claim 1, wherein each of the plurality of surface features includes a textured surface.

8. The test object of claim 1 wherein the plurality of surface features projecting above the planar top surface of the substrate define a first plurality of surface features, the test object further comprising a second plurality of surface features recessed below the planar top surface of the substrate, such that each of the second plurality of surface features define a recessed cavity extending radially outward from the featureless core radius toward the periphery of the substrate.

9. The test object of claim 8 wherein each of the second plurality of surface features recessed include a depth measured orthogonally to planar top surface of substrate that increases from the proximal end to the distal end.

10. The test object of claim 8 wherein the first plurality of surface features and the second plurality of surface features form an alternating three-dimensional pattern projecting above and recessed below the planar surface of the substrate.

11. The test object of claim 10 wherein a cross-section of the alternating three-dimensional pattern at any radius measured from the origin is a periodic waveform.

12. A test object for assessment of a three-dimensional scanner, comprising:
a substrate having a substantially planar top surface; and
a first plurality of three-dimensional surface features projecting above the planar top surface of the substrate, each of the plurality of surface features defined by a unique height measured orthogonally to the planar top surface; and
a second plurality of three-dimensional surface features recessed below the planar top surface of the substrate, each of the plurality of surface features defining a recessed cavity having a unique depth measured orthogonally to the planar top surface of the substrate.

13. The test object of claim 12, wherein at least one of the first plurality of three-dimensional surface features comprises a hemisphere having an equator that is co-planar with the planar top surface of the substrate.

14. The test object of claim 13, wherein at least one of the second plurality of three-dimensional surface features comprises a recessed cavity defining a hemisphere having an equator that is co-planar with the planar top surface of the substrate.

15. The test object of claim 12, wherein each of the first plurality of surface features and each of the second plurality of surface features include a textured surface.

16. The test object of claim 12, wherein at least one of the first plurality of three-dimensional surface features comprises a rectangular prism.

17. The test object of claim 16, wherein at least one of the second plurality of three-dimensional surface features comprises a recessed cavity defining a rectangular prism.

18. The test object of claim 12 comprised of one of a metal, a plastic, or a ceramic material.
